(19) United States
(12) Patent Application Publication
(10) Pub. No.: US 2015/0346685 A1
(43) Pub. Date: Dec. 3, 2015

(54) DEVICE FOR GENERATING PATTERNED LIGHT INTERFERENCE

(71) Applicant: HAMAMATSU PHOTONICS K.K., Shizuoka (JP)

(72) Inventors: Haruyasu ITO, Hamamatsu-shi (JP); Takashi INOUE, Hamamatsu-shi (JP); Hiroshi SAITO, Hamamatsu-shi (JP); Haruyoshi TOYODA, Hamamatsu-shi (JP)

(21) Appl. No.: 14/654,929

(22) PCT Filed: Oct. 24, 2013
(86) PCT No.: PCT/JP2013/078866

§ 371 Date: Jun. 23, 2015

(30) Foreign Application Priority Data
Dec. 25, 2012 (JP) 2012-281162

(51) Int. Cl. G03H 1/22; B23K 26/067; G03H 1/08

(52) U.S. Cl. CPC G03H 1/2205; G03H 1/0891; B23K 26/0676

(57) ABSTRACT

A patterned light interference generating device 1 is provided with a laser light source 10; a wavefront controller 20 for receiving laser light, presenting a hologram pattern to control the wavefront of the laser light, and outputting wavefront-controlled light; an imaging optical system 40 for imaging the wavefront-controlled light at a target position 2; a filter 50 arranged at a portion of concentration by the imaging optical system 40; and a control unit 30 for controlling the hologram pattern; the filter 50 has a plurality of slits in one-to-one correspondence to a plurality of bright spots of a desired order; each of the plurality of slits has an elongated shape extending radially from a center of the plurality of bright spots of the desired order; one end on the center side of each of the plurality of slits is separated from the center.

### TECHNICAL FIELD

The present invention relates to a device for generating desired patterned light interference and, particularly, for generating patterned light interference with a two-dimensionally periodic intensity distribution pattern.

### BACKGROUND ART

In laser processing or the like to finely process the surface or the interior of a workpiece, attention has been drawn to patterned light interference generating apparatus enabling multipoint simultaneous processing. The patterned light interference generating apparatus is configured, for example, to use a diffractive optical element to divide a single beam of light into a plurality of beams of light (a plurality of bright spots: multiple beams) and make these light beams interfere with each other (multi-beam interference), thereby generating desired patterned light interference, e.g., patterned light interference with a two-dimensionally periodic intensity distribution pattern. With this patterned light interference, it becomes feasible to perform periodic multipoint fine processing at one time. The patterned light interference generating apparatus of this kind is disclosed in Patent Literatures 1 and 2 and in Non Patent Literatures 1 and 2.

The patterned light interference generating apparatus described in Patent Literature 1 and Non Patent Literature 1 (which is a three-dimensional holographic recording device 1 to perform multi-photon exposure in a photosensitive material 7) is provided with a laser light source 2 for generating laser light, a diffractive optical element (diffraction beam splitter) 3 for dividing the laser light into a plurality of light beams, two lenses 4 and 5 for concentrating the plurality of laser beams, and an aperture 6 for selecting four beams out of the plurality of laser beams, arranged between the two lenses.

The patterned light interference generating apparatus described in Patent Literature 2 (which is a laser processing device for performing a large number of fine processing processes on the surface of a glass substrate) is provided with a diffractive optical element (first mask) 13 in which holes are arranged in a two-dimensional pattern, first and second projection lenses 11 and 12, and a filter (second mask 14) arranged at a focal point between the first and second projection lenses to interrupt the spots other than the zeroth- and first-order Fourier-transformed images out of Fourier-transformed images of diffracted light.

The patterned light interference generating apparatus described in Non Patent Literature 2 (which is a laser beam interference device) is provided with a diffractive optical element (transmissive diffraction grating (DOE)) for dividing a laser beam into the zeroth-order light and a plurality of first-order light beams, two achromatic convex lenses, and a filter (damper) arranged between the two lenses to interrupt the zeroth-order light.

### CITATION LIST

### Patent Literatures

Patent Literature 1: Japanese Patent Application Laid-open Publication No. 2004-126312
Patent Literature 2: Japanese Patent Application Laid-open Publication No. H11-216580

### Non Patent Literatures

Non Patent Literature 1: Toshiaki Kondo et. al., “Femtosecond laser interference technique with diffractive beam splitter for fabrication of three-dimensional photonic crystals,” Applied Physics Letters Vol. 79, No. 6, 2001, pp. 725-727
Non Patent Literature 2: Yoshiki NAKATA, “Generation of periodic metal three-dimensional nano-structure by interfering femtosecond laser processing,” The Amada Foundation, Report of researches and international exchanges, 24 (2012), pp. 221-225

### SUMMARY OF INVENTION

### Technical Problem

Incidentally, the laser processing is desirably processing that allows us to change the shape and periodic intervals of the periodic structure for fine processing. Namely, the patterned light interference generating apparatus is desirably configured to allow us to change the shape and periodic intervals of the periodic structure of the patterned light interference.

Concerning this point, the devices disclosed in Patent Literatures 1 and 2 and Non Patent Literatures 1 and 2 are configured to change the shape or spacing of the diffraction grating of the diffractive optical element and the aperture shape or spacing of the filter, thereby allowing us to change the shape and periodic intervals of the periodic structure of the patterned light interference. In this case, however, it is necessary for us to replace the diffractive optical element and the filter with other components every change of the shape and periodic intervals of the periodic structure of the patterned light interference, with the result of decrease of operation efficiency.

Therefore, it is an object of the present invention to provide a patterned light interference generating device allowing us to readily change the shape and periodic intervals of the periodic structure of the patterned light interference.

### Solution to Problem

A patterned light interference generating device according to the present invention is a device for generating desired patterned light interference at a target position, comprising: a laser light source for generating laser light; a wavefront controller for receiving the laser light from the laser light source, presenting a hologram pattern to control the wavefront of the laser light in a plurality of pixels arranged in a two-dimensional array, and outputting wavefront-controlled light; an imaging optical system for imaging the wavefront-controlled light from the wavefront controller at the target position; a filter arranged at a portion of concentration by the imaging optical system; and a control unit for controlling the hologram pattern presented in the wavefront controller, so as to generate a plurality of bright spots of a desired order at the portion of concentration by the imaging optical system, wherein the filter has a plurality of slits in one-to-one correspondence to the plurality of bright spots of the desired order, wherein each of the plurality of slits has an elongated shape extending radially from a center of the plurality of bright spots of the desired order, and wherein one end on the center side of each of the plurality of slits is separated from the center.

In the patterned light interference generating device of the present invention, the control unit controls the hologram pattern presented in the wavefront controller, whereby the device can readily change the number of bright spots of the desired order generated at the portion of concentration by the imaging optical system, arrangement thereof, and intervals with respect to the center of the plurality of bright spots of the desired order, so as to readily change the shape and periodic intervals of the periodic structure of the patterned light interference generated at the target position after passage through the filter and the imaging optical system. For example, the shape (processing shape) of the periodic structure of the patterned light interference generated at the target position can be changed by changing the number and arrangement of bright spots of the desired order generated at the portion of concentration by the imaging optical system. Furthermore, the periodic intervals (processing intervals) of the periodic structure of the patterned light interference generated at the target position can be changed, for example, by changing the intervals between the bright spots of the desired order generated at the portion of concentration by the imaging optical system and the center of the plurality of bright spots of the desired order.

On that occasion, since the plurality of slits in the filter are of the elongated shape extending radially from the center of the plurality of bright spots of the desired order, there is no need for replacement of the filter, even with the change of the intervals with respect to the center of the bright spots of the desired order, i.e., even with radial movement of the bright spots of the desired order with respect to the center. Therefore, the shape and periodic intervals of the periodic structure of the patterned light interference can be readily changed without need for replacement of the filter.

The one end on the center side of each of the plurality of slits may be located so as not to transmit a bright spot of the zeroth order out of bright spots generated at the portion of concentration by the imaging optical system.

When the intervals with respect to the center of the plurality of bright spots of the desired order are made variable, the other end on the opposite side to the center side of each of the plurality of slits may be located: so as to transmit the corresponding bright spot of the desired order with increase of the intervals with respect to the center of the plurality of bright spots of the desired order; and so as not to transmit higher-order bright spots except for the corresponding bright spot of the desired order with decrease of the intervals with respect to the center of the plurality of bright spots of the desired order.

If the slits in the filter are made too long, the higher-order bright spots except for the bright spots of the desired order will also pass through them with decrease of the intervals with respect to the center of the plurality of bright spots of the desired order, so as to possibly result in failing to obtain the desired patterned light interference. However, this patterned light interference generating device is configured not to transmit the higher-order bright spots except for the bright spots of the desired order, and thus it can prevent degradation of the desired patterned light interference due to mixing of the higher-order bright spots.

When the intervals with respect to the center of the plurality of bright spots of the desired order are made variable, the filter may have: a plurality of first slits corresponding to a part of a variable range as the plurality of slits; and a plurality of second slits corresponding to another part of the variable range as the plurality of slits. At this time, the set of second slits may be rotated by a predetermined amount around the center of the bright spots of the desired order, relative to the set of first slits.

The filter may have the plurality of slits as follows: when N bright spots of the desired order are generated as the plurality of bright spots of the desired order, the filter has N slits in one-to-one correspondence to the N bright spots of the desired order, as the plurality of slits; when M bright spots of the desired order are generated as the plurality of bright spots of the desired order, the filter has M slits in one-to-one correspondence to the M bright spots of the desired order, as the plurality of slits (where N and M are integers of not less than 2 and N and M are different). At this time, the set of M slits may be rotated by a predetermined amount around the center of the bright spots of the desired order, relative to the set of N slits.

### Advantageous Effect of Invention

The present invention enables the patterned light interference generating device to readily change the shape and periodic intervals of the periodic structure of the patterned light interference. As a consequence, the multipoint simultaneous laser processing can be implemented while allowing us to readily change the shape and periodic intervals of the periodic structure for fine processing.

### BRIEF DESCRIPTION OF DRAWINGS

FIG. 1 is a drawing showing a configuration of a patterned light interference generating device according to the first embodiment of the present invention.

FIG. 2 (a) to (d) are drawings showing laser light from a laser light source, a hologram pattern, a plurality of bright spots at a position of focus of an imaging optical system, and patterned light interference at a target position, respectively.

FIGS. 3 (a) and (b) are drawings showing a plurality of bright spots at the position of focus of the imaging optical system in a case of small intervals with respect to a center of first-order diffracted light beams and in a case of small intervals with respect to the center of first-order diffracted light beams, respectively.

FIGS. 4 (a) and (b) are drawings showing a filter in the first example and a filter in the second example, respectively, according to the first embodiment.

FIGS. 5 (a) and (b) are drawings showing a hologram pattern and patterned light interference, respectively, in a case where the intervals with respect to the center of four first-order diffracted light beams are 50 pixels.

FIGS. 6 (a) and (b) are drawings showing a hologram pattern and patterned light interference, respectively, in a case where the intervals with respect to the center of four first-order diffracted light beams are 25 pixels.

FIG. 7 (a) to (c) are bright spots at the output-side focus of lens 41 in both of a case where the intervals with respect to the center Z of three first-order diffracted light beams are 10 pixels and a case where the intervals are 50 pixels, respectively.

FIG. 8 is a drawing showing a configuration of a patterned light interference generating device according to the second embodiment of the present invention.

FIGS. 9 (a) and (b) are drawings showing filters corresponding to cases where three first-order diffracted light beams are generated, one where a variable range of the intervals with respect to the center of these first-order diffracted light beams is from 10 to 35 pixels and the other where the variable range is from 35 to 65 pixels, respectively.

FIGS. 10 (a) and (b) are drawings showing filters corresponding to cases where four first-order diffracted light beams are generated, one where the variable range of the intervals with respect to the center of these first-order diffracted light beams is from 10 to 25 pixels and the other where the variable range is from 25 to 65 pixels, respectively.

FIG. 11 is a drawing showing a filter in the second example according to the second embodiment.

FIG. 12 is a drawing showing a laser processing device according to the embodiment of the invention.

FIG. 13 is a drawing showing an example of the processing result by the laser processing device shown in FIG. 2.

FIG. 14 is a drawing showing a filter according to a modification example of the present invention.

FIGS. 15 (a) and (b) are drawings showing a hologram pattern according to a modification example of the present invention and patterned light interference at the target position, respectively.

### DESCRIPTION OF EMBODIMENTS

Preferred embodiments of the present invention will be described below in detail with reference to the drawings. Identical or equivalent portions will be denoted by the same reference signs in the drawings.

### First Embodiment

### Summary of Configuration

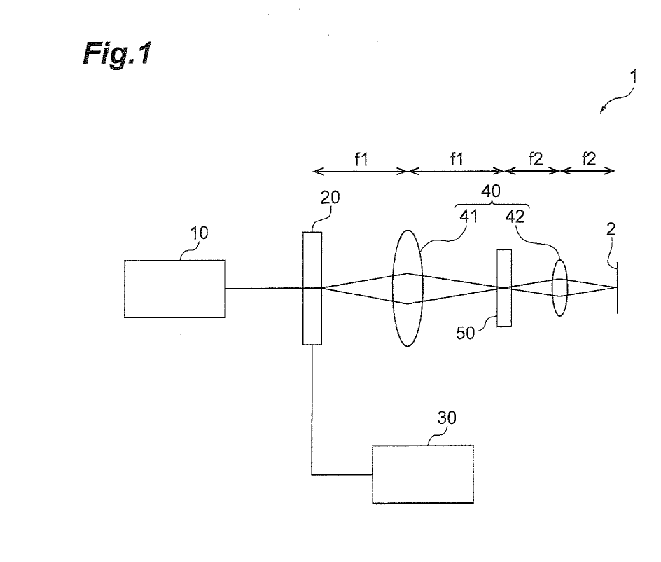

FIG. 1 is a drawing showing a configuration of the patterned light interference generating device according to the first embodiment of the present invention. This patterned light interference generating device 1 generates desired patterned light interference, e.g., patterned light interference with a two-dimensionally periodic intensity distribution pattern, at a target position 2. This patterned light interference generating device 1 is provided with a laser light source 10, a wavefront controller 20, a control unit 30, an imaging optical system 40, and a filter 50.

The laser light source 10 is a light source for generating laser light to be irradiated toward the target position 2. When the patterned light interference generating device 1 of the present embodiment is applied to laser processing, the laser light source 10 to be suitably used is a pulsed laser light source that generates short pulsed light with the pulse width from several hundred picoseconds to several femtoseconds. The laser light output from the laser light source 10 is guided directly or via a predetermined optical system into the wavefront controller 20.

The wavefront controller 20 to be used is one that can dynamically control the wavefront, such as a phase modulation type spatial light modulator (SLM: Spatial Light Modulator) or a deformable mirror. The spatial light modulator and deformable mirror may be those of a transmission type or a reflection type. The spatial light modulator may be any one of the LCD (Liquid Crystal Display) type, LCOS (Liquid Crystal on Silicon) type, MEMS (Micro Electro Mechanical Systems) type, optically addressed type, magneto optical type, and so on. The below will describe cases where the transmissive LCOS-type spatial light modulator (LCOS-SLM) is used as the wavefront controller 20 by way of illustration.

This wavefront controller 20 receives the laser light from the laser light source 10, presents a hologram pattern to control the wavefront of the laser light (or modulate the phase) in a plurality of pixels arranged in a two-dimensional array, and outputs wavefront-controlled light (modulated light after phase modulation). The hologram pattern presented in this wavefront controller 20 is preferably a hologram obtained by numerical computation (CGH: Computer Generated Hologram).

The operation of the wavefront controller 20 and the hologram pattern presented in the wavefront controller 20 are controlled by the control unit 30. The control unit 30 is a unit that sets wavefront control amounts (phase modulation amounts) at the respective pixels in the wavefront controller 20, and supplies a signal for setting the wavefront control amounts for the respective pixels, to the wavefront controller 20, so as to make the predetermined hologram pattern presented in the wavefront controller 20. Such control unit 30 can be configured, for example, by a computer having a CPU, a ROM, a RAM, and so on.

The wavefront-controlled light output from the wavefront controller 20 is guided into the imaging optical system 40. The imaging optical system 40 consists of a pair of lenses 41, 42 and images the wavefront-controlled light at the target position 2. When the patterned light interference generating device 1 of the present embodiment is used for fine processing, the imaging optical system 40 is preferably a reduction optical system, which images the wavefront-controlled light at the target position 2. The lens 41 is arranged so that its input-side focus (focal length f1) is located at an output plane of the wavefront controller 20, while the lens 42 is arranged so that its input-side focus (focal length f2) is located at the output-side focus (focal length f1) of the lens 41 and so that its output-side focus (focal length f2) is located at the target position 2. The lens 41 effects the Fourier transform and the lens 41 does the inverse Fourier transform.

The filter 50 for letting only desired wavefront-controlled light pass out of the wavefront-controlled light output from the wavefront controller 20 is provided between these lenses 41, 42. The filter 50 is located at the output-side focus (also referred to as Fourier plane) of the lens 41 and at the input-side focus of the lens 42, i.e., at a concentration position (portion of concentration) by the imaging optical system 40. The filter 50 transmits bright spots of a desired order (+first-order diffracted light beams) at the output-side focus of the lens 41 and, in other words, it interrupts the bright spots other than the bright spots of the desired order (+first-order diffracted light beams).

Next, the wavefront controller 20, control unit 30, and filter 50 will be described in detail.

### First Example

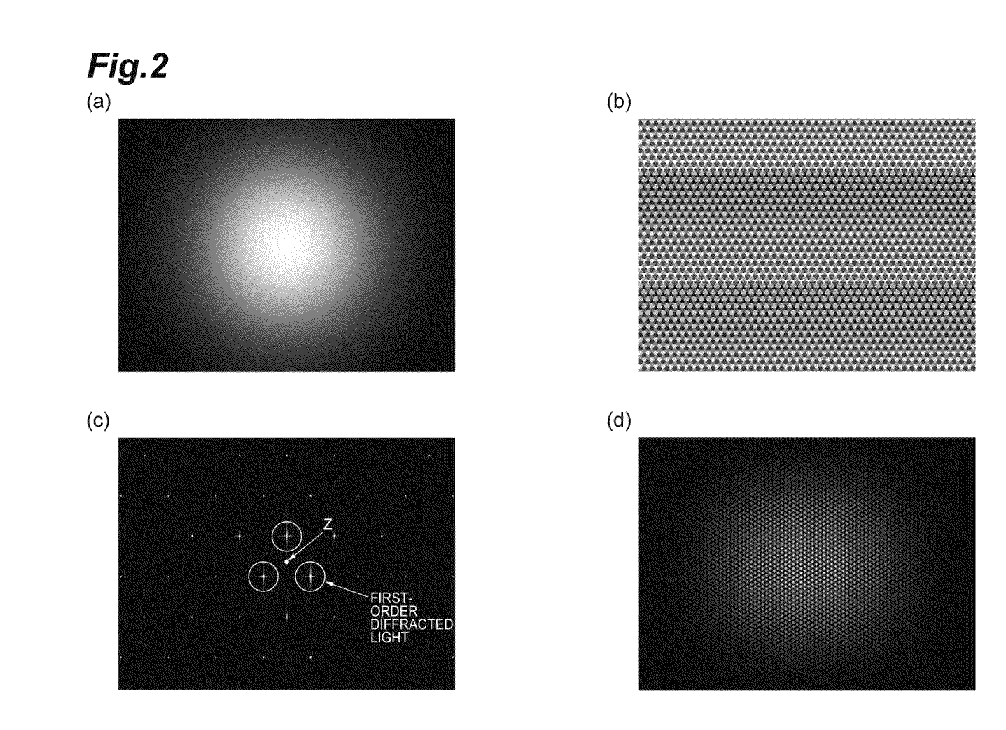

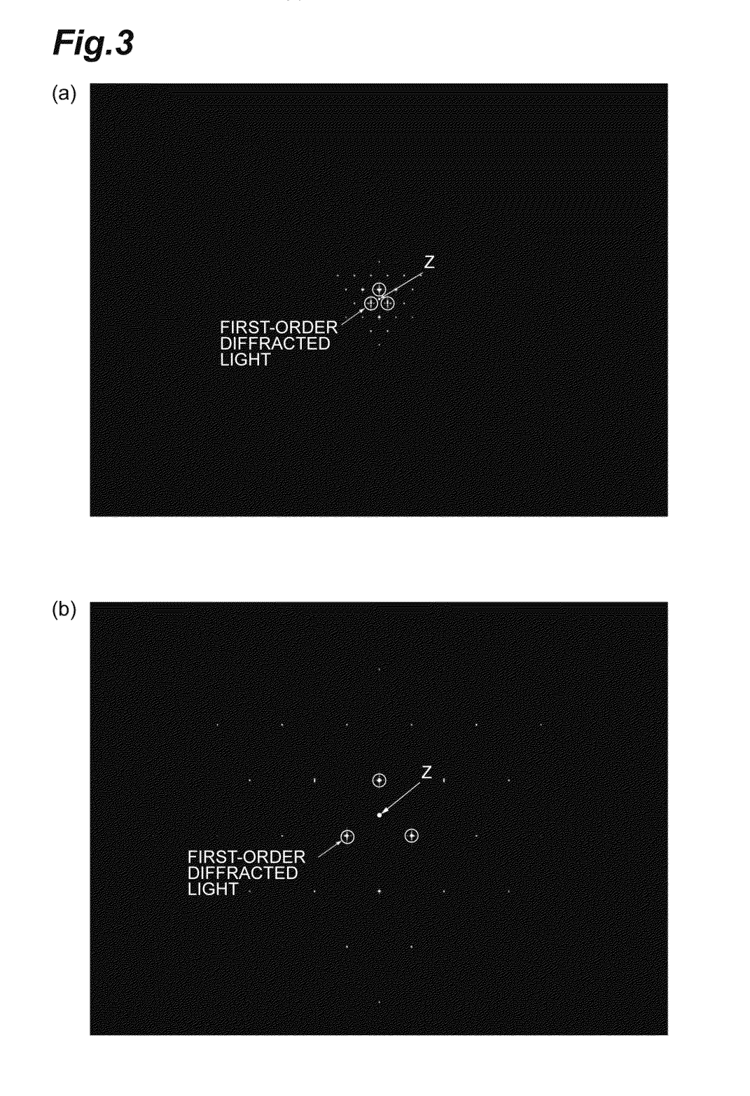

The wavefront controller 20, control unit 30, and filter 50 in the first example will be described with reference to FIGS. 2 and 3. FIG. 2 (a) shows the laser light from the laser light source 10, which is the laser light to be guided into the wavefront controller 20, and the wavefront of this laser light is flat, i.e., in phase. FIG. 2 (b) shows the hologram pattern presented in the wavefront controller 20 by the control unit 30. FIG. 2 (c) shows a plurality of bright spots formed at the output-side focus of the lens 41 after the Fourier transform by the lens 41. In this manner, the first example is configured so that the control unit 30 controls the hologram pattern presented in the wavefront controller 20 so as to generate three first-order diffracted light beams at the output-side focus of the lens 41. In the present example, the three first-order diffracted light beams are generated as separated by 50 pixels (the number of pixels in the input image) from a center Z of these first-order diffracted light beams in radial directions perpendicular to the optical-axis direction, while arranged at equal intervals on a concentric circle around this center Z.

FIG. 2 (d) shows the patterned light interference at the target position 2 obtained thereafter through such operation that the filter 50 interrupts the zeroth-order light and higher-order diffracted light beams other than the three first-order diffracted light beams, or transmits the three first-order diffracted light beams and that the lens 42 effects the inverse Fourier transform thereof. In this manner, the filter 50 allows the three first-order diffracted light beams to pass, whereby the patterned light interference with a two-dimensionally periodic intensity distribution pattern is obtained at the target position 2.

The control unit 30 controls the hologram pattern presented in the wavefront controller 20, so as to change the intervals with respect to the center Z of the three first-order diffracted light beams, as shown in FIG. 3, whereby the periodic intervals of the periodic structure of the patterned light interference at the target position 2 can be readily changed. For example, when the intervals with respect to the center Z of the three first-order diffracted light beams are decreased as shown in FIG. 3 (a), the periodic intervals of the periodic structure of the patterned light interference at the target position can be widened; whereas, when the intervals with respect to the center Z of the three first-order diffracted light beams are increased as shown in FIG. 3 (b), the periodic intervals of the periodic structure of the patterned light interference at the target position can be narrowed.

However, the change of the intervals with respect to the center Z of the first-order diffracted light beams leads to a need for also changing positions of transmission holes in the filter, and thus it becomes necessary to change the filter itself.

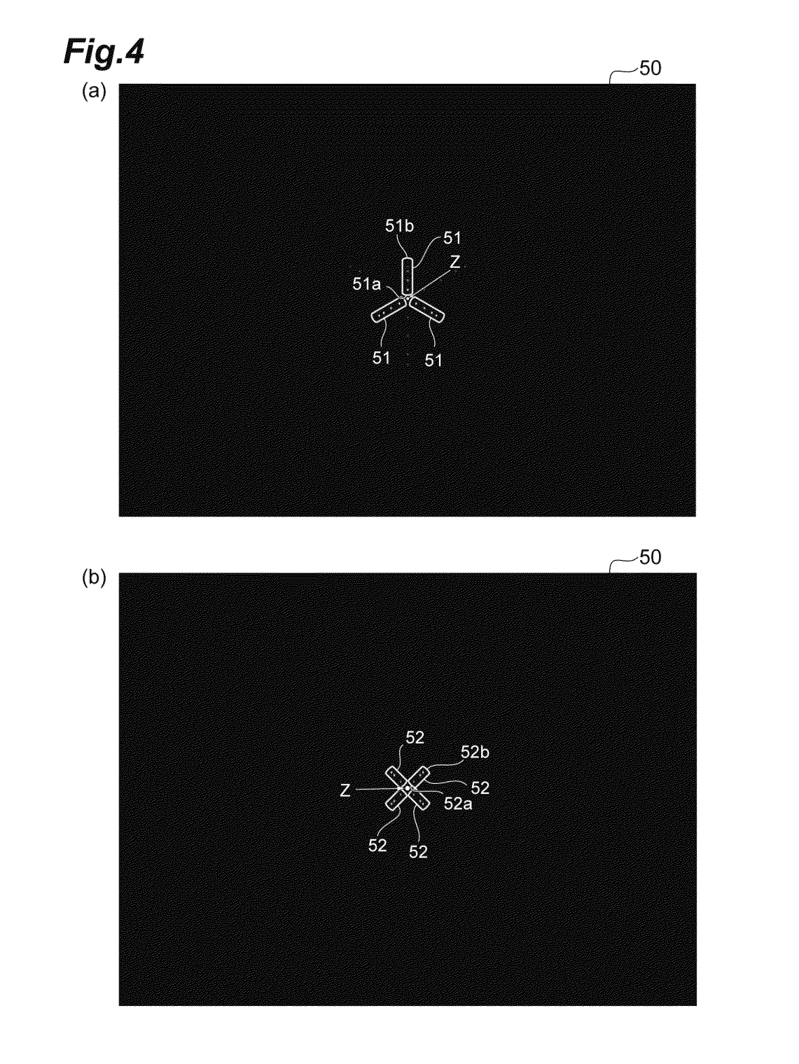

In the first example, therefore, the filter 50 has three slits 51 of an elongated shape extending radially from the center Z, as shown in FIG. 4 (a). The three slits 51 are arranged in one-to-one correspondence to the three first-order diffracted light beams, respectively. One end 51a on the center Z side of each of the three slits 51 is separated from the center Z so as not to transmit the zeroth-order diffracted light.

In this patterned light interference generating device 1 in the first example of the first embodiment, the control unit 30 controls the hologram pattern presented in the wavefront controller 20, whereby the intervals with respect to the center Z of the first-order diffracted beams generated at the output-side focus of the lens 41 can be readily changed, so as to readily change the periodic intervals of the periodic structure (processing intervals) of the patterned light interference generated at the target position 2.

In this regard, since the three slits 51 in the filter 50 are of the elongated shape extending radially from the center Z, there is no need for replacing the filter 50 with another, even with change of the intervals with respect to the center Z of the first-order diffracted light beams, or, even with radial movement of the first-order diffracted light beams with respect to the center.

### Second Example

Next, the wavefront controller 20, control unit 30, and filter 50 in the second example will be described. The second example is different from the first example in that the control unit 30 controls the hologram pattern presented in the wavefront controller 20, so as to generate four first-order diffracted light beams (bright spots of the desired order) at the output-side focus of the lens 41. The four first-order diffracted light beams are generated as separated by 50 pixels (the number of pixels in the input image) from a center Z of these first-order diffracted light beams in radial directions perpendicular to the optical-axis direction, while arranged at equal intervals on a concentric circle around this center Z.

Furthermore, the second example is different from the first example, as shown in FIG. 4 (b), in that the filter 50 has four slits 52 of an elongated shape extending radially from the center Z. The four slits 52 are arranged in one-to-one correspondence to the four first-order diffracted light beams, respectively. One end 52a on the center Z side of each of the four slits 52 is separated from the center Z so as not to transmit the zeroth-order diffracted light.

This patterned light interference generating device 1 in the second example of the first embodiment can also achieve the same advantage as the patterned light interference generating device 1 in the first example.

The patterned light interference generating devices 1 in the first and second examples as described above are configured so that the control unit 30 controls the hologram pattern presented in the wavefront controller 20, so as to readily change the number of first-order diffracted light beams generated at the output-side focus of the lens 41, and, as a result, the devices can readily change the shape (processing shape) of the periodic structure of the patterned light interference generated at the target position 2.

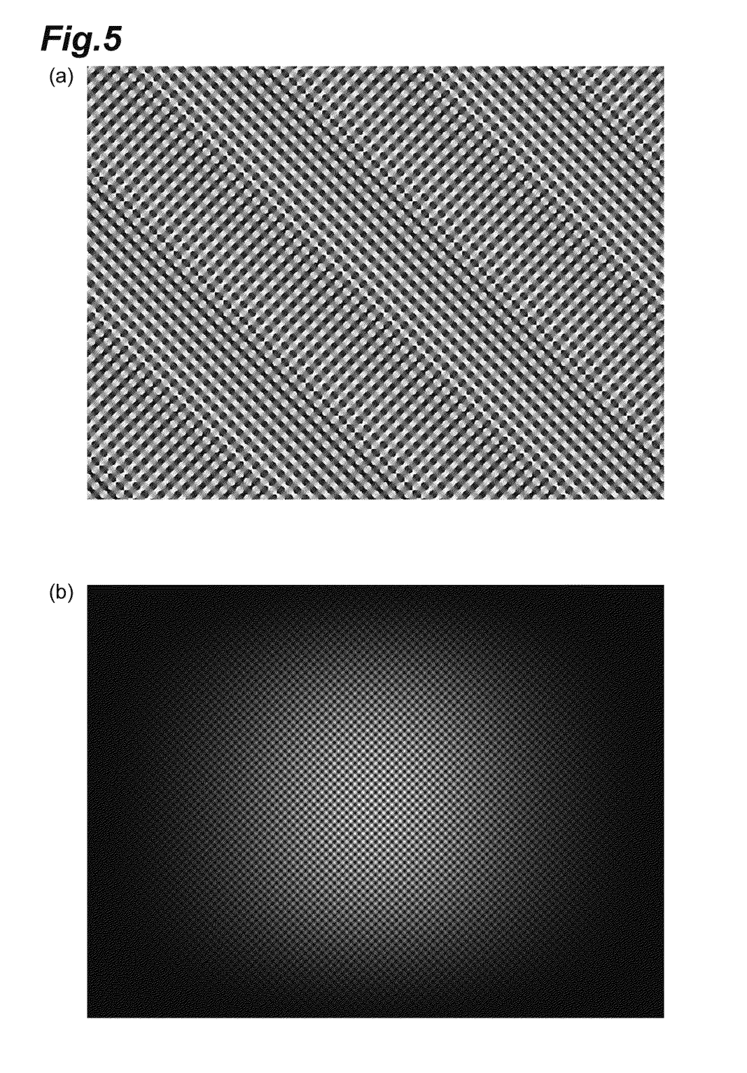

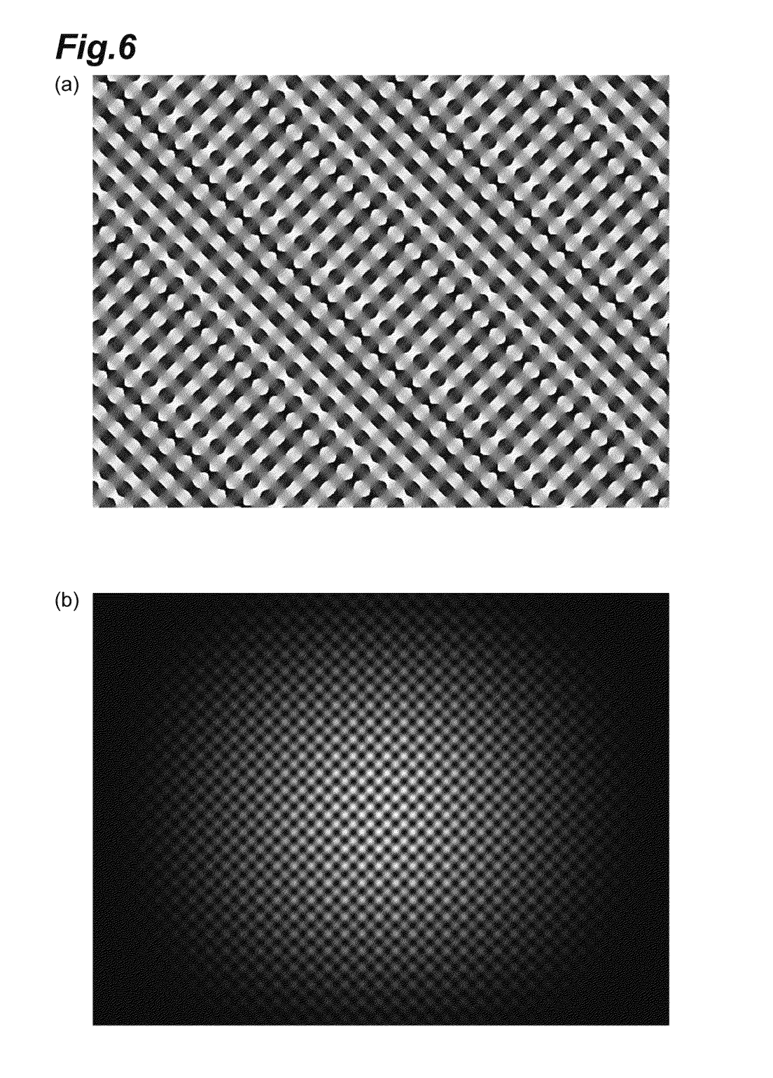

The below will describe the results of verification of the above-described operational effect. FIG. 5 (a) and FIG. 6 (a) show respective hologram patterns presented in the wavefront controller 20 by the control unit 30. These hologram patterns are for generating four first-order diffracted light beams at the output-side focus of the lens 41, and these are different in that the hologram pattern shown in FIG. 5 (a) is one for generating the first-order diffracted light beams separated by 50 pixels from the center Z, whereas the hologram pattern shown in FIG. 6 (a) is one for generating the four first-order diffracted light beams separated by 25 pixels from the center Z. FIG. 5 (b) and FIG. 6 (b) show respective patterns of the patterned light interference at the target position 2 obtained thereafter through such operation that the filter 50 interrupts the zeroth-order light and higher-order light beams other than the four first-order diffracted light beams, or transmits the four first-order diffracted light beams and that the lens 42 effects the inverse Fourier transform thereof.

It is seen from FIG. 5 that an increase of the intervals with respect to the center Z of the four first-order diffracted light beams leads to a decrease of the periodic intervals of the periodic structure of the patterned light interference at the target position 2. Furthermore, it is seen from FIG. 6 that a decrease of the intervals with respect to the center Z of the four first-order diffracted light beams leads to an increase of the periodic intervals of the periodic structure of the patterned light interference at the target position 2.

### Third Example

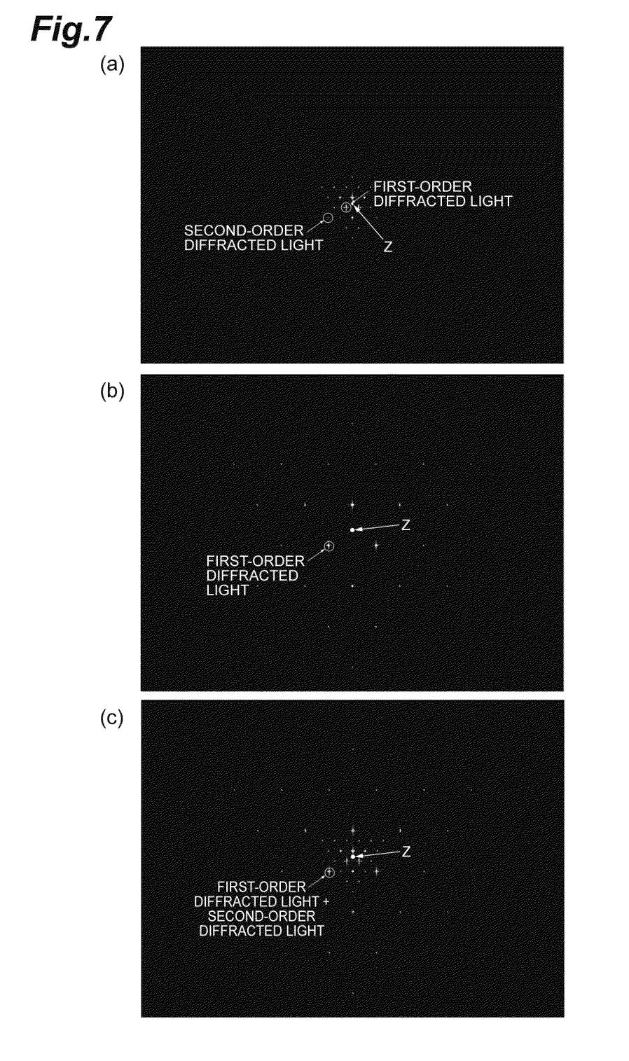

FIG. 7 (a) shows bright spots at the output-side focus of the lens 41 in a case where the intervals with respect to the center Z of three first-order diffracted light beams are ten pixels, and FIG. 7 (b) bright spots at the output-side focus of the lens 41 in a case where the intervals with respect to the center Z of three first-order diffracted light beams are fifty pixels. FIG. 7 (c) shows superposition of FIG. 7 (a) and FIG. 7 (b). It is seen from FIG. 7 (c) that the increase of the intervals with respect to the center Z of the first-order diffracted light beams leads to spatial superposition of the first-order diffracted light beams in the case of the intervals being fifty pixels, on the second-order diffracted light beams in the case of the intervals being ten pixels.

If the filter has the elongated slits that can transmit the first-order diffracted light beams with the intervals thereof with respect to the center Z ranging from 10 pixels to over 50 pixels, the filter will transmit the first-order diffracted light beams and the second-order diffracted light beams in the case of the intervals being 10 pixels and it can result in failing to obtain the desired patterned light interference (desired processing result).

In the third example, therefore, the control unit 30 restricts a variable range of the intervals with respect to the center Z of the three first-order diffracted light beams in the first example. The filter 50 has the slits 51 that do not allow the second- and higher-order diffracted light beams to pass, even with variation in the intervals with respect to the center Z of the first-order diffracted light beams.

For example, the control unit 30 restricts the variable range of the intervals with respect to the center Z of the three first-order diffracted light beams to a range from 10 to 35 pixels. In this case, as shown in FIG. 4 (a), the other end 51b on the opposite side to the center Z side of each of the three slits 51 is located so as to transmit the corresponding first-order diffracted light beam with an increase of the intervals of the first-order diffracted light beams with respect to the center Z to 35 pixels and so as not to transmit the higher-order diffracted light beams except for the corresponding first-order diffracted light beam with a decrease of the intervals of the first-order diffracted light beams with respect to the center Z to 10 pixels.

This patterned light interference generating device 1 in the third example of the first embodiment can also achieve the same advantage as the patterned light interference generating device 1 in the first example.

Furthermore, this patterned light interference generating device 1 in the third example can prevent degradation of the desired patterned light interference (processing degradation) due to mixing of second-order diffracted light.

### Fourth Example

Similarly, in the fourth example, the control unit 30 restricts the variable range of the intervals with respect to the center Z of the four first-order diffracted light beams in the second example. Furthermore, the filter 50 has the slits 52 that do not transmit the second- and higher-order diffracted light beams, even with variation in the intervals with respect to the center Z of the first-order diffracted light beams.

For example, the control unit 30 restricts the variable range of the intervals with respect to the center Z of the three first-order diffracted light beams to a range from 10 pixels to 25 pixels. In this case, as shown in FIG. 4 (b), the other end 52b on the opposite side to the center Z side of each of the four slits 52 is located so as to transmit the corresponding first-order diffracted light beam with an increase of the intervals of the first-order diffracted light beams with respect to the center Z to 25 pixels and so as not to transmit the higher-order diffracted light beams except for the corresponding first-order diffracted light beam with a decrease of the intervals of the first-order diffracted light beams with respect to the center Z to 10 pixels.

This patterned light interference generating device 1 in the fourth example of the first embodiment can also achieve the same advantage as the patterned light interference generating devices 1 in the second and third examples.

### Second Embodiment

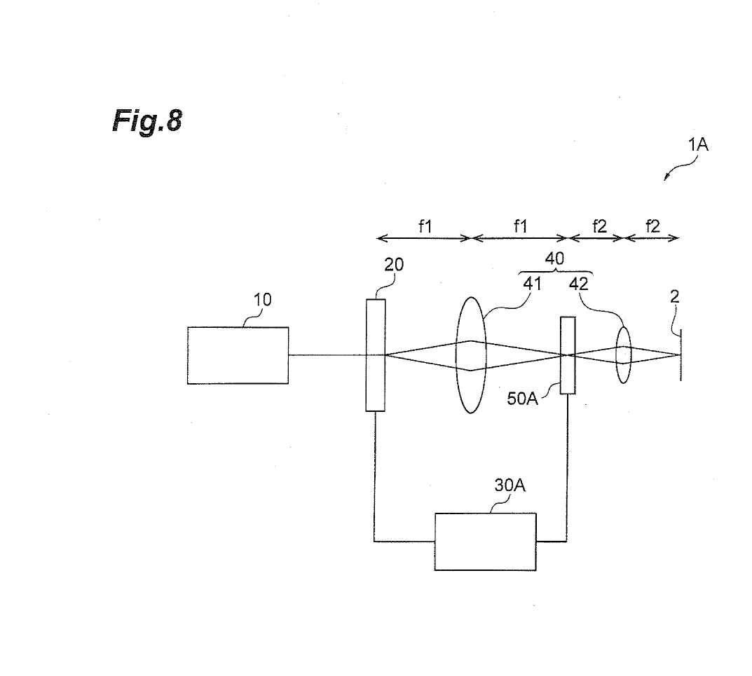

FIG. 8 is a drawing showing a configuration of the patterned light interference generating device according to the second embodiment of the present invention. This patterned light interference generating device 1A is different from the first embodiment in that it is provided with the control unit 30A and filter 50A, instead of the control unit 30 and filter 50 in the patterned light interference generating device 1.

### First Example

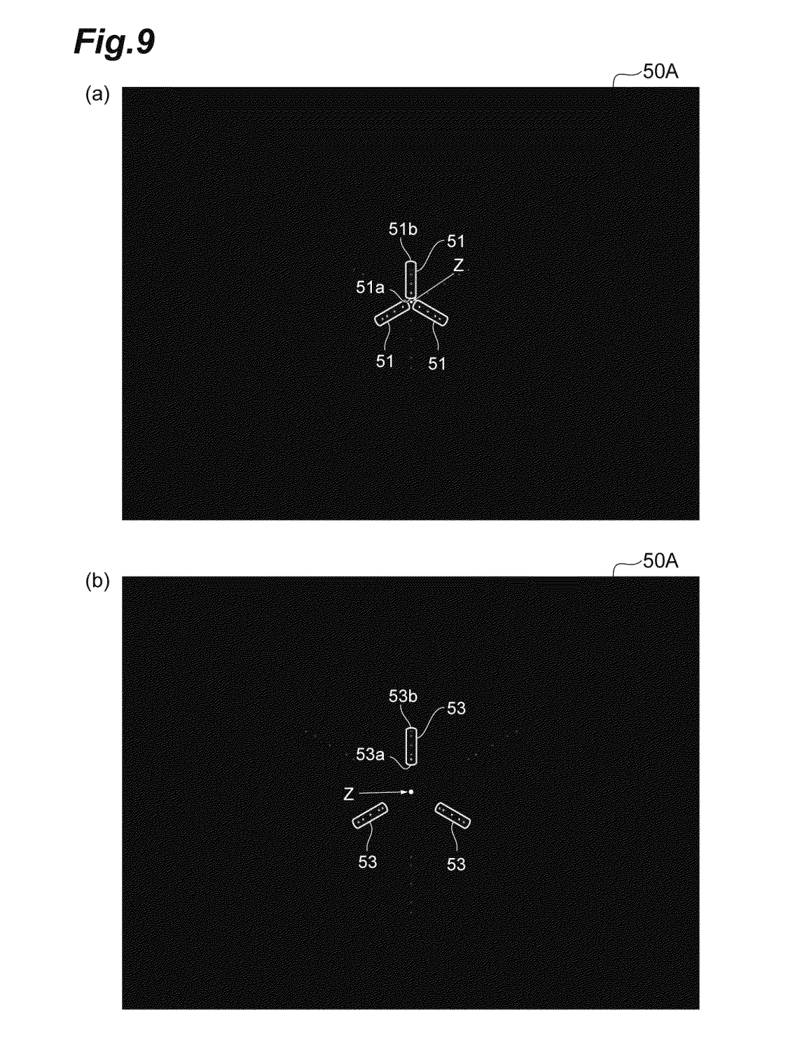

First, the wavefront controller 20, control unit 30A, and filter 50A in the first example will be described. The filter 50A includes four filters. The first filter 50A is the same as the filter 50 in the third example of the first embodiment described above. Namely, as shown in FIG. 9 (a), the first filter 50A has the three slits 51 corresponding to a case where the three first-order diffracted light beams are generated and where the variable range of the intervals with respect to the center Z of these first-order diffracted light beams is from 10 to 35 pixels. The second filter 50A has three slits 53 corresponding to a case where the three first-order diffracted light beams are generated and where the variable range of the intervals with respect to the center Z of these first-order diffracted light beams is from 35 to 65 pixels, as shown in FIG. 9 (b).

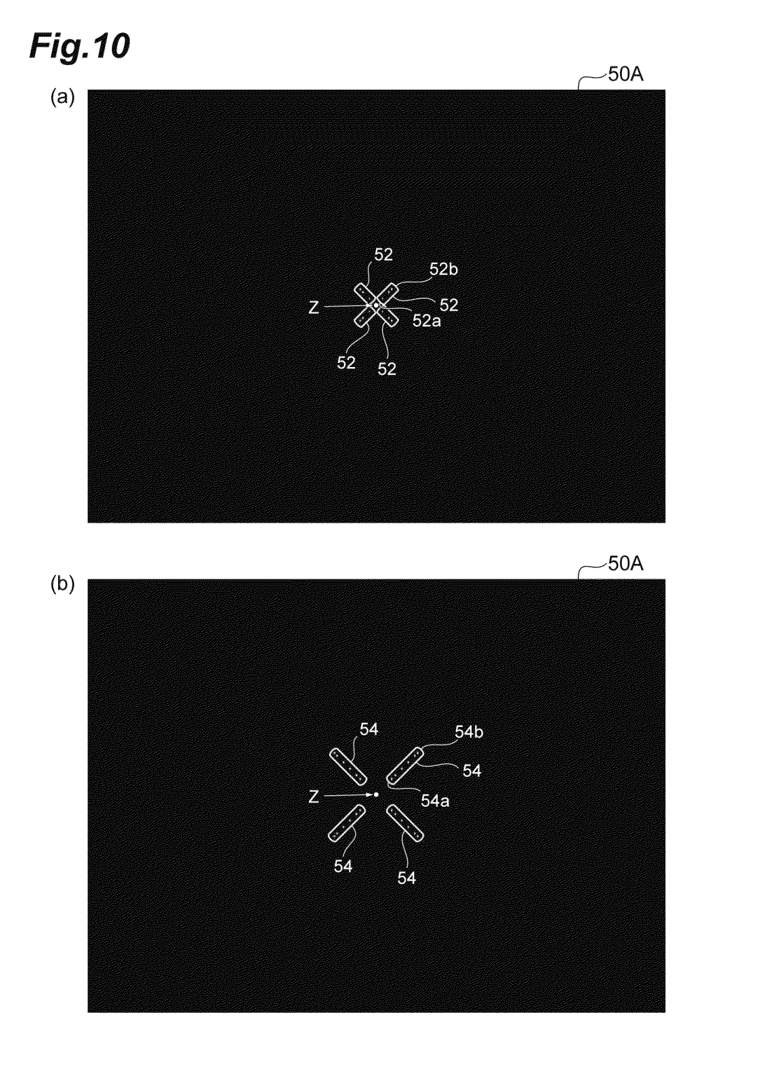

The third filter 50A is the same as the filter 50 in the fourth example of the first embodiment described above. Namely, as shown in FIG. 10 (a), the third filter 50A has the four slits 52 corresponding to a case where the four first-order diffracted light beams are generated and where the variable range of the intervals with respect to the center Z of these first-order diffracted light beams is from 10 to 25 pixels. The fourth filter 50A has four slits 54 corresponding to a case where the four first-order diffracted light beams are generated and where the variable range of the intervals with respect to the center Z of these first-order diffracted light beams is from 25 to 65 pixels, as shown in FIG. 10 (b). These four filters 50A are mounted, for example, on a switching mechanism arranged as mechanically slidable or rotatable, and this switching mechanism is controlled by the control unit 30A.

The control unit 30A, in addition to the aforementioned function of the control unit 30, performs selective switching among the four filters 50A through control of the foregoing switching mechanism in accordance with the hologram pattern presented in the wavefront controller 20.

This patterned light interference generating device 1A in the first example of the second embodiment can also achieve the same advantage as the patterned light interference generating device 1 in the first example of the first embodiment.

### Second Example

Next, the wavefront controller 20, control unit 30A, and filter 50A in the second example will be described. The second example is different from the first example in that the filter 50A constitutes one filter having all the sets of slits 51 to 54 described above.

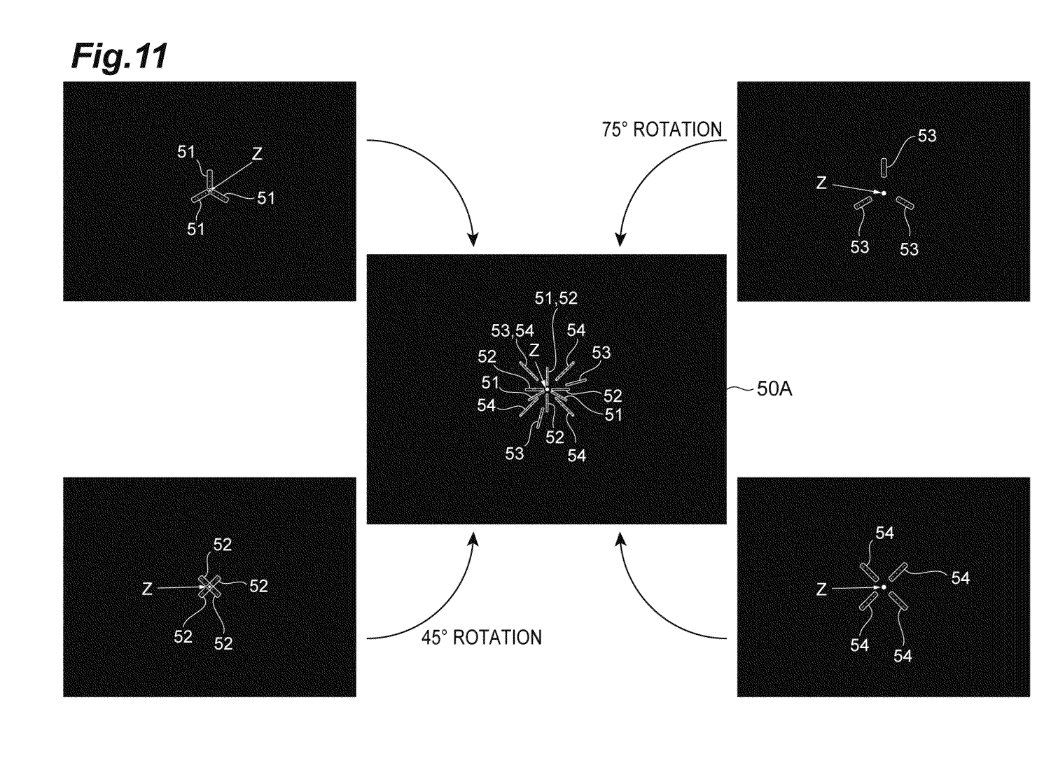

For example, as shown in FIG. 11, the filter 50A has the aforementioned set of three slits 51, the aforementioned set of four slits 52 as a set of slits 52 resulting from about 45° (or about −45°) rotation around the center Z, the aforementioned set of three slits 53 as a set of slits 53 resulting from about 75° (or about −75°) rotation around the center Z, and the aforementioned set of four slits 54. This filter 50A is rotationally controlled by the control unit 30A.

The control unit 30A, in addition to the aforementioned function of the control unit 30, performs selective switching among the sets of slits 51 to 54 through rotational control of the filter 50A in accordance with the hologram pattern presented in the wavefront controller 20. It is noted that the hologram pattern may be subjected to rotational control, instead of the rotational control of the filter 50A.

This patterned light interference generating device 1A in the second example of the second embodiment can also achieve the same advantage as the patterned light interference generating device 1 in the first example of the first embodiment.

### [Application to Laser Processing Device]

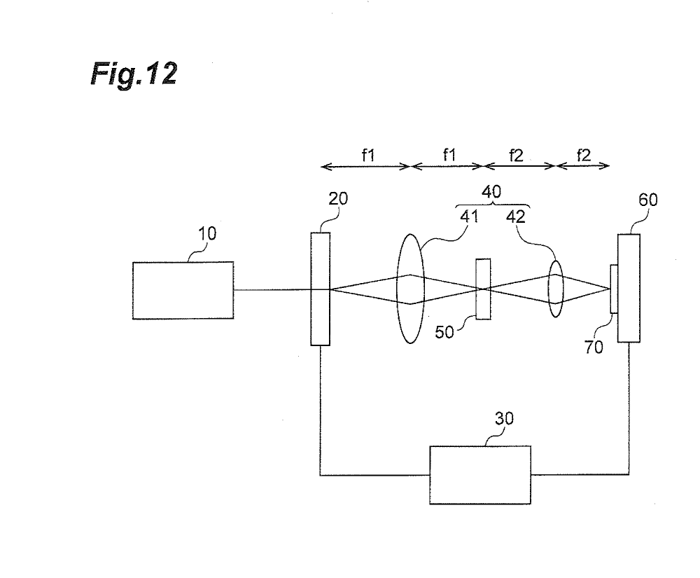

The below will describe an example of application where the patterned light interference generating device of the present invention is applied to a laser processing device. FIG. 12 is a drawing showing the laser processing device equipped with the patterned light interference generating device 1 in the first example of the first embodiment. This laser processing device has a stage 60, in addition to the patterned light interference generating device 1 in the first example of the first embodiment, and is configured to irradiate the patterned light interference to the surface or interior of a workpiece 70 arranged on this stage 60. Furthermore, the device can perform large-area processing by repetitively performing the processing with movement of the stage 60. The movement of the stage 60 is controlled by the control unit 30.

When the stage 60 and the wavefront controller 20 are made to operate in conjunction with each other to dynamically control the wavefront with movement of the workpiece 70, it also becomes feasible to implement different processing processes at respective positions on the workpiece 70.

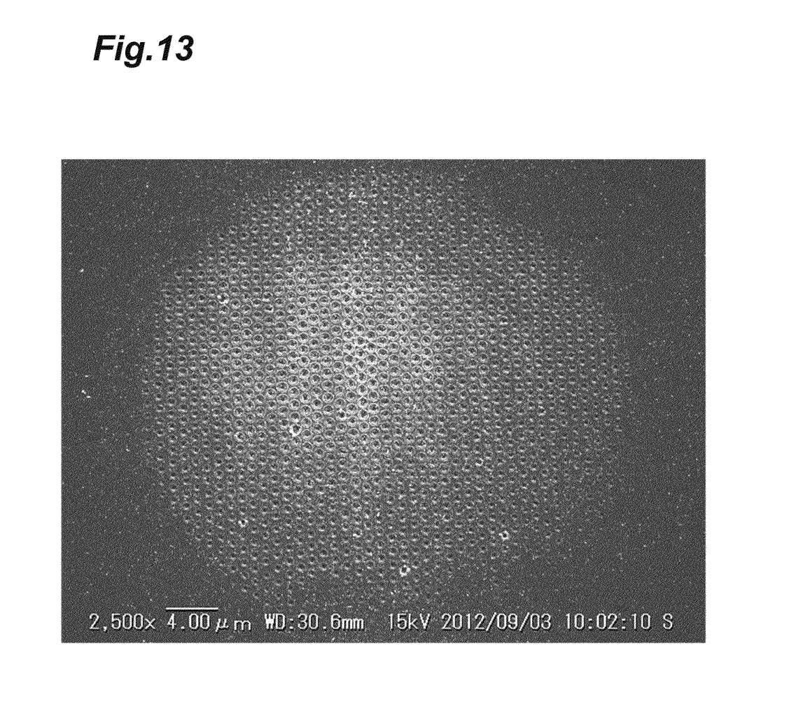

FIG. 13 is a drawing showing an enlarged view of the surface of the workpiece processed by the laser processing device shown in FIG. 12. In FIG. 13, the laser light source to be used was one to emit picosecond short pulsed laser light with the beam diameter Φ of 12 mm, the pulse width of 1.0 ps, the center wavelength of 515 nm, the repetitive frequency of 1 kHz, and the average intensity of 0.15 W, thereby generating three spots of first-order diffracted light beams with the intervals of 36 pixels with respect to the center Z, on the Fourier plane. Thereafter, the laser light was reduced to Φ43 μm through the imaging optical system 40 and the filter 50 to be applied to the surface of the workpiece. The workpiece used was a silicon wafer.

It was confirmed by FIG. 13 that the silicon wafer was periodically finely processed. It was confirmed by this result that the present invention effectively functioned in practical processing.

It should be noted that the present invention is by no means intended to be limited to the embodiments of the invention as described above but can be modified in various ways. For example, the embodiments of the invention were configured so that the control unit 30 controls the hologram pattern presented in the wavefront controller 20, so as to generate the three or four first-order diffracted light beams at the position of concentration by the imaging optical system 40, but the features of the present invention can be applied to general cases where two or more first-order diffracted light beams (bright spots of the desired order) are generated at the position of concentration by the imaging optical system 40. In such cases, the filter has the slits as many as the number of first-order diffracted light beams (bright spots of the desired order).

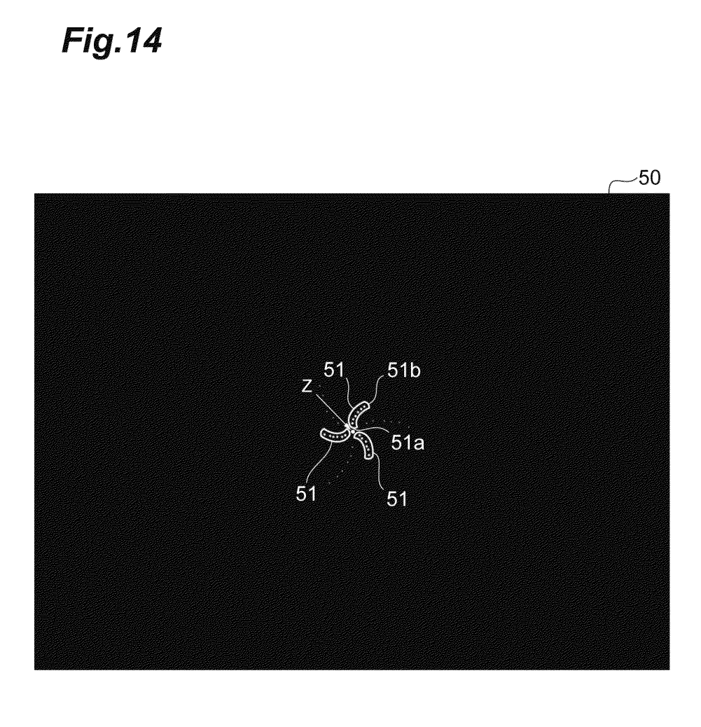

The embodiments of the invention were configured so that the slits 51-54 in the filter 50 linearly extended in radial directions from the center Z but the slits in the filter may be those nonlinearly extending in radial directions from the center Z as shown in FIG. 14, with the same advantage as in the embodiments of the invention.

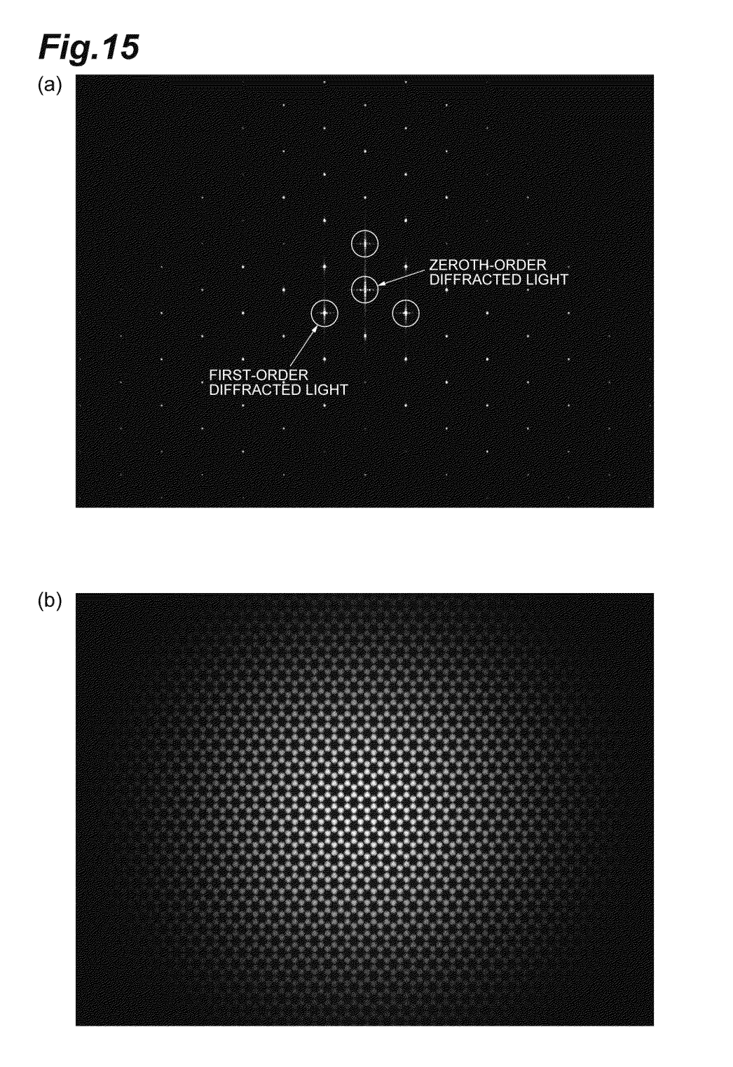

The device may be configured in such a configuration that the hologram pattern to be used is one to generate a bright spot with the intensity three times larger at the position of the center Z, at the position of concentration by the imaging optical system 40, as shown in FIG. 15 (a), and that the filter to be used is one to interrupt this light at the center Z. Then, we can obtain the patterned light interference different from those in the embodiments, as shown in FIG. 15 (b). In this manner, when the control unit controls the hologram pattern presented in the wavefront controller to change the arrangement of the bright spots of the desired order generated at the position of concentration by the imaging optical system, the device can change the shape of the periodic structure of the patterned light interference generated at the target position after passage through the filter and the imaging optical system.

In the patterned light interference generating devices 1, 1A of the embodiments of the invention, an optical component may be further inserted, if necessary, between the constitutive elements.

### INDUSTRIAL APPLICABILITY

The present invention is applicable to uses of the patterned light interference generating devices allowing us to readily change the shape and periodic intervals of the periodic structure of the patterned light interference.

### REFERENCE SIGNS LIST

1, 1A patterned light interference generating devices
2 target position
10 laser light source
20 wavefront controller
30, 30A control units
40 imaging optical system
41, 42 lenses
50, 50A filters
51 to 54 slits
51a to 54a one ends on the center side of the slits
51b to 54b other ends on the opposite side to the center side of the slits
60 stage
70 workpiece
Z center of bright spots of desired order

1. A device for generating desired patterned light interference at a target position, comprising:
a laser light source for generating laser light;
a wavefront controller for receiving the laser light from the laser light source, presenting a hologram pattern to control the wavefront of the laser light in a plurality of pixels arranged in a two-dimensional array, and outputting wavefront-controlled light;
an imaging optical system for imaging the wavefront-controlled light from the wavefront controller at the target position;
a filter arranged at a portion of concentration by the imaging optical system; and
a control unit for controlling the hologram pattern presented in the wavefront controller, so as to generate a plurality of bright spots of a desired order at the portion of concentration by the imaging optical system,
wherein the filter has a plurality of slits in one-to-one correspondence to the plurality of bright spots of the desired order,
wherein each of the plurality of slits has an elongated shape extending radially from a center of the plurality of bright spots of the desired order, and
wherein one end on the center side of each of the plurality of slits is separated from the center.

2. The device for generating patterned light interference according to claim 1,
wherein the one end on the center side of each of the plurality of slits is located so as not to transmit a bright spot of the zeroth order out of bright spots generated at the portion of concentration by the imaging optical system.

3. The device for generating patterned light interference according to claim 1,
wherein, when intervals with respect to the center of the plurality of bright spots of the desired order are made variable, the other end on the opposite side to the center side of each of the plurality of slits is located:
so as to transmit the corresponding bright spot of the desired order with increase of the intervals with respect to the center of the plurality of bright spots of the desired order; and
so as not to transmit higher-order bright spots except for the corresponding bright spot of the desired order with decrease of the intervals with respect to the center of the plurality of bright spots of the desired order.

4. The device for generating patterned light interference according to claim 1,
wherein, when intervals with respect to the center of the plurality of bright spots of the desired order are made variable, the filter has: a plurality of first slits corresponding to a part of a variable range as the plurality of slits; and a plurality of second slits corresponding to another part of the variable range as the plurality of slits.

5. The device for generating patterned light interference according to claim 1,
wherein the filter has the following slits:
when N bright spots of the desired order are generated as the plurality of bright spots of the desired order, the filter has N slits in one-to-one correspondence to the N bright spots of the desired order, as the plurality of slits; and
when M bright spots of the desired order are generated as the plurality of bright spots of the desired order, the filter has M slits in one-to-one correspondence to the M bright spots of the desired order, as the plurality of slits,
(where N and M are integers of not less than 2 and N and M are different).

6. The device for generating patterned light interference according to claim 4,
wherein the set of the plurality of second slits is rotated by a predetermined amount around the center of the bright spots of the desired order, relative to the set of the plurality of first slits.

7. The device for generating patterned light interference according to claim 5,
wherein the set of the M slits is rotated by a predetermined amount around the center of the bright spots of the desired order, relative to the set of the N slits.
